(19) United States
(12) Patent Application Publication
(10) Pub. No.: US 2024/0263498 A1
(43) Pub. Date: Aug. 8, 2024

(54) Portable Door Lock

(71) Applicant: Brayden Hunter, Cantonment, FL (US)

(72) Inventor: Brayden Hunter, Cantonment, FL (US)

(21) Appl. No.: 18/432,764

(22) Filed: Feb. 5, 2024

Related U.S. Application Data
(60) Provisional application No. 63/483,551, filed on Feb. 7, 2023.

(51) Int. Cl. E05C 19/18

(52) U.S. Cl. CPC E05C 19/182

(57) ABSTRACT

A portable lock includes a latch member and a keeper member. The latch member has a cross member connected with a post. The post is arranged substantially perpendicular to the cross member. The keeper member has an opening formed therein to receive the post. The keeper member is positioned onto the post with the keeper member, the cross member, and the post together forming a latching assembly. The latching assembly is positioned with the post in a door jamb between a sidewall adjacent to a door and a side of the door. The cross member is positioned against a first side of the door after the door is closed, and the keeper member is positioned against a second side of the door after the door is closed, thereby securing the door in a closed configuration with the sidewall adjacent to the door.

### PRIORITY CLAIM

This application claims the priority filing benefit of U.S. Provisional Patent Application No. 63/483,551 filed Feb. 7, 2023 for “Portable Door Lock” of Brayden Hunter, hereby incorporated by reference in its entirety as though fully set forth herein.

### BACKGROUND

Public restroom stalls often include simple latches to secure or “lock” the stall door for privacy. Over time, and with ongoing use and even abuse, these latches often break. It is common to find stall doors with missing or broken latches that cannot be secured for privacy.

A plastic clip such as the commercially available STALL STOPPER™ or STALL NINJA™ may be carried and used in place of a missing or broken lock. These appear to have components that could be easily broken.

### BRIEF DESCRIPTION OF THE DRAWINGS

FIG. 1 is a perspective view of an example portable door lock.

FIG. 2 is an inside view showing the example portable door lock of FIG. 1 as it may be implemented to secure a restroom stall door in a closed position.

FIG. 3 is an outside view showing the example portable door lock corresponding to FIG. 2 as it may be implemented to secure a restroom stall door in a closed position.

FIG. 4 is a top view of the example portable door lock.

FIG. 5 is a side view of the example portable door lock.

FIG. 6 is a transparent view showing internal aspects of a keeper member of the example portable door lock.

FIG. 7 is a top view of the keeper member of the example portable door lock corresponding to FIG. 6.

FIG. 8 is a side view of the keeper member of the example portable door lock corresponding to FIG. 6.

FIG. 9 is another side view of the keeper member of the example portable door lock corresponding to FIG. 6.

FIG. 10 is a perspective view of a latch member of the example portable door lock.

FIG. 11 is a side view of the latch member of the example portable door lock corresponding to FIG. 10.

FIG. 12 is a top view of the latch member of the example portable door lock corresponding to FIG. 10.

FIG. 13 is another side view of the latch member of the example portable door lock corresponding to FIG. 10.

FIG. 14 is a perspective view of another example keeper member of the example portable door lock.

FIG. 15 is a perspective view of the example keeper member of the example portable door lock corresponding to FIG. 10 with a strap shown hanging on the keeper member for purposes of illustration.

### DETAILED DESCRIPTION

A portable lock is disclosed as it may be implemented, for example, as a door lock or securement on bathroom stall doors where the latch (or “lock”) is broken or missing. In an example, the portable lock is a keychain sized device that can be readily carried in a pocket, purse, handbag, or backpack, etc., and implemented to secure or hold a bathroom stall door shut. In an example, the portable lock adjusts to fit any stall partition thickness.

In an example, the portable lock may have more than one different use. By way of illustration, the portable lock may also be used as a coat hanger, a purse hanger, and a personal safety device. For example, the tip may be hardened metal to work as a glass breaker. As another example, the portable lock may include a bottle opener.

The portable lock may be made from any suitable material, including but not limited to metal (e.g., lightweight aluminum), or even a strong plastic.

A portable lock includes a latch member and a keeper member. The latch member has a cross member or brace connected with a post. The post is arranged substantially perpendicular to the cross member. The keeper member has an opening formed therein to receive the post. The keeper member is positioned onto the post with the keeper member, the cross member, and the post together forming a latching assembly. The latching assembly is positioned with the post in a door jamb between a sidewall adjacent to a door and a side of the door. The cross member is positioned against a first side of the door after the door is closed, and the keeper member is positioned against a second side of the door after the door is closed, thereby securing the door in a closed configuration with the sidewall adjacent to the door.

In an example, the post and the opening in the keeper are threaded. In use, the keeper is threaded onto the post to lock the door, and the keeper is unthreaded from the post to unlock the door. However, other mechanisms for coupling the keeper to the post are also contemplated. By way of a non-limiting example, the keeper and the post can be ratcheted.

In an example, the keeper and the latch can be installed on various types of surfaces and is not limited to installation on a public restroom stall. Examples include, but are not limited to, other types of doors, walls, countertops, tables, etc. In an example, the keeper and the latch can be installed on different sizes of surfaces. For example, the same keeper and latch can be connected to thin or thick doors. The size of the surface on which the keeper and latch can be installed is only limited by the length of the post.

In an example, the portable door lock is multifunctional. For example, the keeper may include one or more hanger for hanging coats, purses, backpacks, etc. The portable door lock may thus be used as both a door lock and simultaneously or separately as a hanger or hook.

In an example, the portable door lock may be utilized as a personal safety mechanism. For example, the keeper may include a hardened tip for breaking glass in an emergency.

In an example, the portable door lock may be utilized as a bottle top opener, for example by including a top opener on the keeper.

Still other modifications may be included on the latch and/or keeper for utilizing the portable door lock in a variety of different situations.

Despite being described herein as a “lock” due to its function when used to secure a door, it is noted that the mechanism may serve as a latch or other securement means, and is not to be narrowly interpreted or limited in nature by any definition of the term “lock,” except to the extent any such definition of the term “lock” may be expressly recited in the claims.

Before continuing, it is noted that as used herein, the terms “includes” and “including” mean, but is not limited to, “includes” or “including” and “includes at least” or “including at least.” The term “based on” means “based on” and “based at least in part on.”

It is also noted that the examples described herein are provided for purposes of illustration, and are not intended to be limiting. Other devices and/or device configurations may be utilized to carry out the operations described herein.

The operations shown and described herein are provided to illustrate example implementations. It is noted that the operations are not limited to the ordering shown. Still other operations may also be implemented.

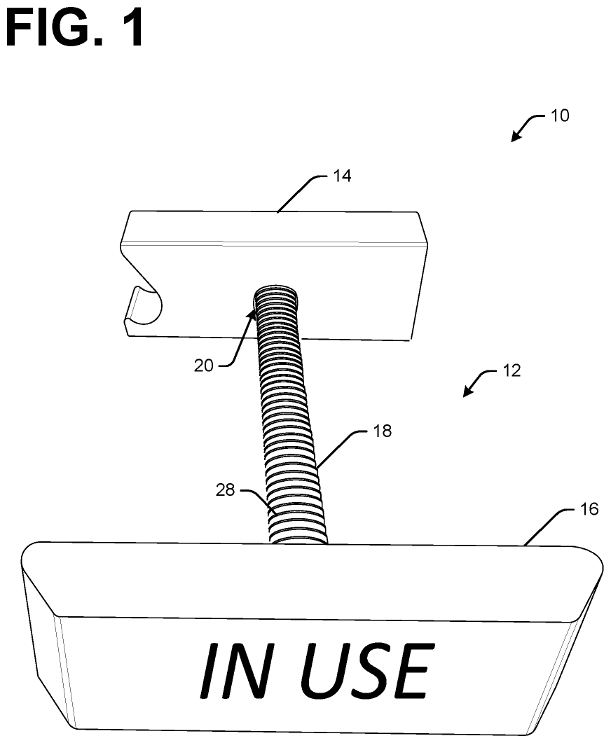

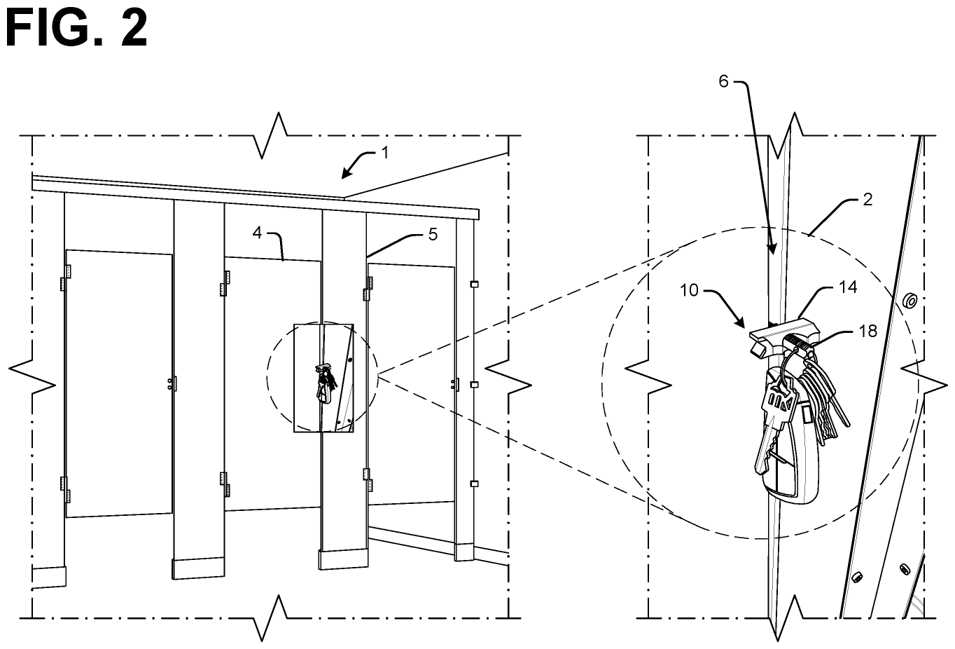

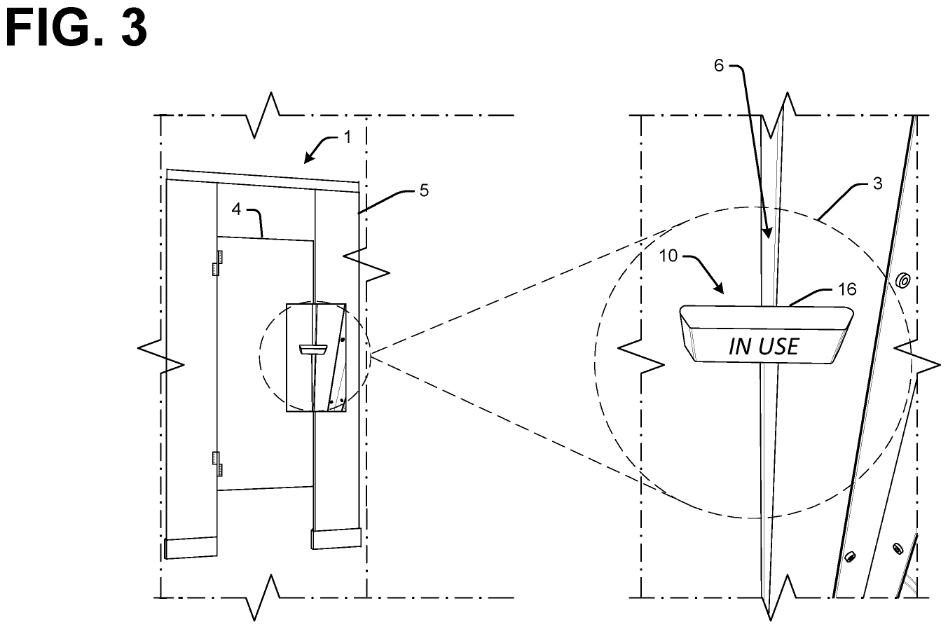

FIG. 1 is a perspective view of an example portable door lock 10. In an example, the portable lock 10 includes a latch member 12 and a keeper member 14. The latch member 12 has a cross brace or member 16 connected with a post 18. For example, the cross member 16 and post 18 may be formed together (i.e., integral to one another) or the cross member 16 may otherwise be affixed to the post 18. The post 18 is arranged substantially perpendicular to the cross member 16 such that it forms a T-shape. The keeper member 14 has an opening 20 formed therein to receive the post 18. The keeper member 14 is positioned onto the post 18 with the keeper member 14, the cross member 16, and the post 18 together forming a latching assembly, which can be implemented to secure a closed door , as shown by way of illustration in FIGS. 2 and 3.

FIG. 2 is an inside view showing the example portable door lock 10 of FIG. 1 as it may be implemented to secure a stall door 4 to a latch jamb provided, e.g., by an adjacent wall 5 in a restroom 1. A close up view 2 of the example portable door lock 10 is also shown in FIG. 2 in a closed position. FIG. 3 is an outside view showing the example portable door lock 10 corresponding to FIG. 2 as it may be implemented to secure a stall door 4 to a latch jamb provided, e.g., by an adjacent wall 5 in a restroom 1. A close up view 3 of the example portable door lock 10 is also shown in FIG. 3 in a closed position.

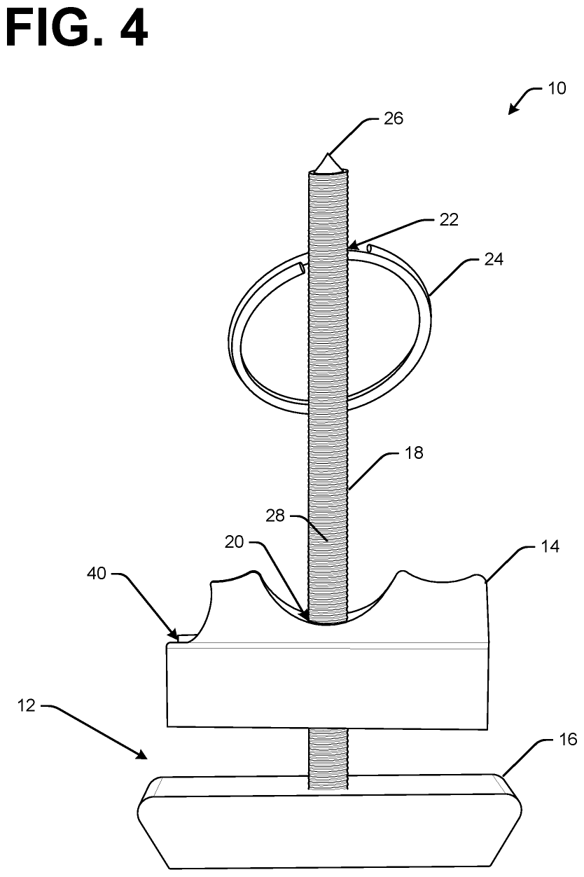

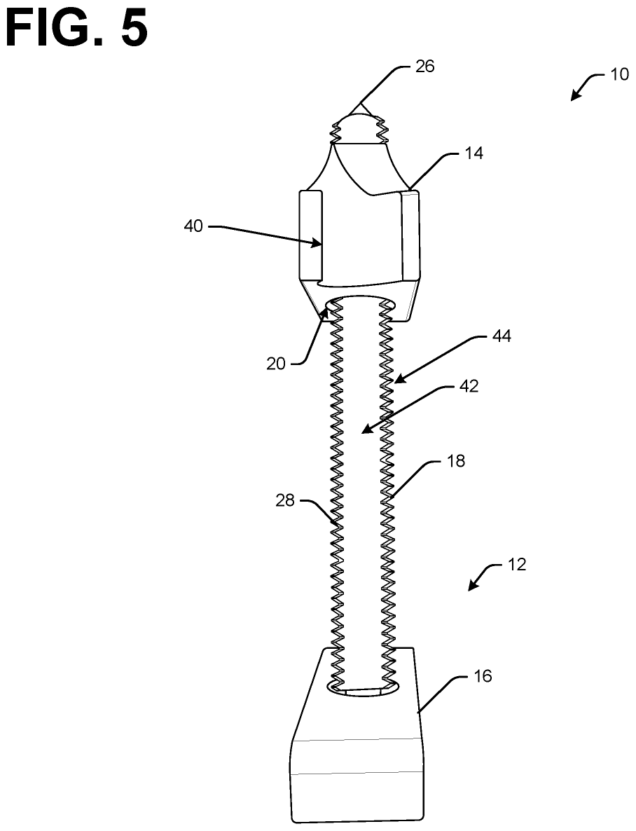

With reference to FIGS. 2 and 3, the latching assembly (including the latch member 12 and keeper member 14) is positioned with the post 18 in a gap 6 formed between the door 4 and the latch jamb 5. It is noted that the gap 6 is often quite narrow, so as to prevent people from looking into the stall and thus removing some of the privacy provided by the door 4. As such, the post 18 may be configured so as to fit within the narrow gap 6, as will be discussed by way of illustration in more detail below with reference to FIGS. 4 and 5. For now, suffice it to say that the post 18 fits in the gap 6 formed between the edge of the door 4 and the latch jamb 5.

The post 18 may be provided between the latching side of the door 4 and the latch jamb 5 (e.g., provided in a sidewall adjacent to the door). The cross member 16 is positioned against a first side of the door 4 (e.g., the outside facing side of the door) when the door 4 is closed to latch the outside of the door 4 to the latch jamb 5. The keeper member 14 is positioned against a second side of the door 4 (e.g., the inside facing side of the door) when the door 4 is closed to latch the inside of the door 4 to the latch jamb 5. As such, the door 4 is secured on each side (by the cross member 16 and the keeper member 14) to be “locked” or otherwise retained in a closed configuration with the sidewall 5 that is adjacent to the door 4, as seen, for example, in FIGS. 2 and 3.

In an example, the keeper member 14 is positioned onto the post 18 with the keeper member 14, the cross member 16, and the post 18 together forming the latching assembly. In this assembled configuration, the latching assembly is now raised above the already closed door (or lowered below the door) to locate the gap 6. The post 18 is slid between the sidewall 5 adjacent to the door 4 and the latching edge of the door 4. It is noted that the post 18 may have a length sufficient to accommodate different thickness doors so that it can be used on a variety of different doors. The latching assembly is moved along the gap 6 to the desired position, with the cross member 16 positioned on the outside of the first side of the door 4 (e.g., the outside facing side of the door), and the keeper member 14 positioned on the outside of the second side of the door 4 (e.g., the outside facing side of the door). The keeper member 14 may then be tightened against the inside surface of the door 4 and latch jamb 5 (e.g., by rotating clockwise to tighten, ratcheting, or otherwise securing against), thereby “locking” the door 4 in the closed position.

As noted above, the post 18 may be configured so as to fit within the gap 6, which is often a narrow gap. In an example, the post 18 is configured with a narrow side, and a wider side. FIG. 4 is a top view of the example portable door lock 10 showing a wider side having ribs or threads 28. An opening 22 may be formed through the post 18, and a keyring 24 is shown in FIG. 4 as it may be connected through the opening 22 formed through the post 18. Also visible in FIG. 4 is a hardened tip or glass break tip 26 which may be provided on the post 18, e.g., for breaking glass in an emergency. It is noted that these features may be provided on other areas of the portable door lock 10, such as, but not limited to on the keeper member 14.

FIG. 5 is a side view of the example portable door lock 10 showing a narrower side of the post 18 without ribbing or threads 28. The post 18 may have at least one flat side 42 and at least one ribbed side 44. In the example shown, the post 18 has two flat sides 42 which are opposite each other, and two ribbed sides 44 which are opposite each other and adjacent to the two flat sides 42. In this example, the post 18 is at least partially threaded, and the opening 20 in the keeper member 14 has a corresponding thread. As such, the keeper member 14 can be threaded onto the post 18 (e.g., by rotating clockwise) to tighten the latching assembly and secure the door 4 in the closed configuration as described above. The keeper member 14 can be unthreaded from the post 18 (e.g. by rotating counter-clockwise) to loosen and remove the latching assembly to permit opening of the door 4.

It is noted that any suitable means for tightening and loosening the latching assembly may be provided. By way of non-limiting example, the keeper member 14 may 14 may ratchet onto the post 18 via a suitable ratchet mechanism, or simply frictionally engage when pushed over the ribs or threads 28 on the post 18.

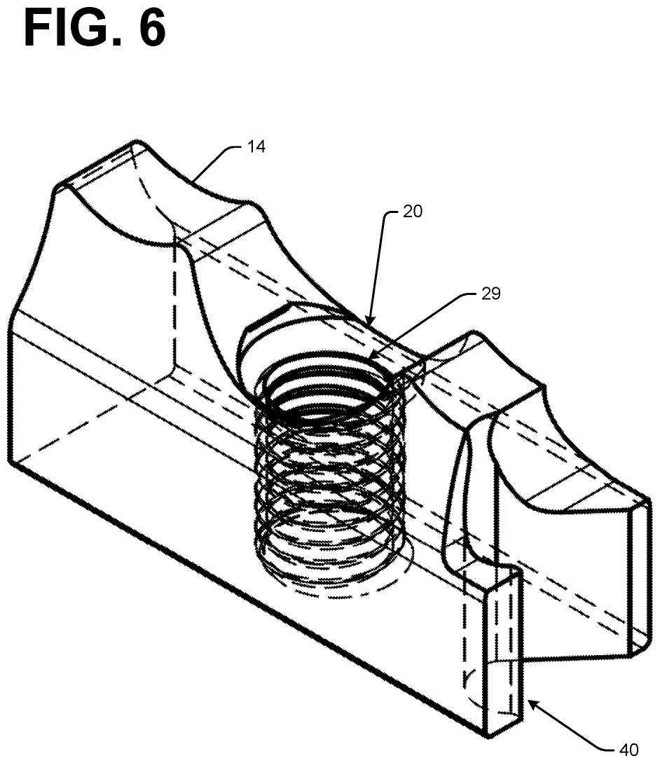

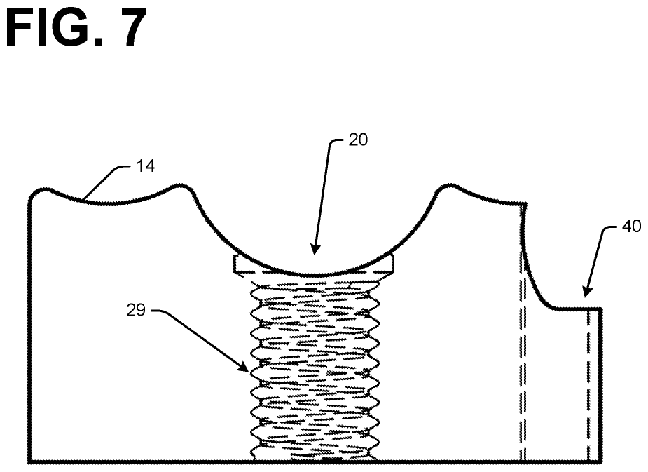

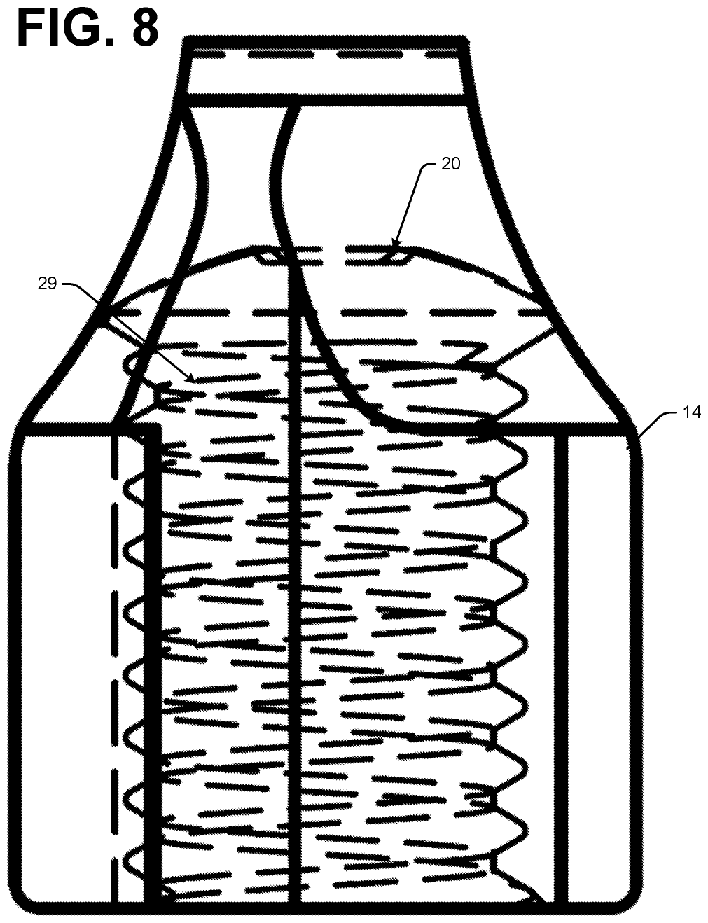

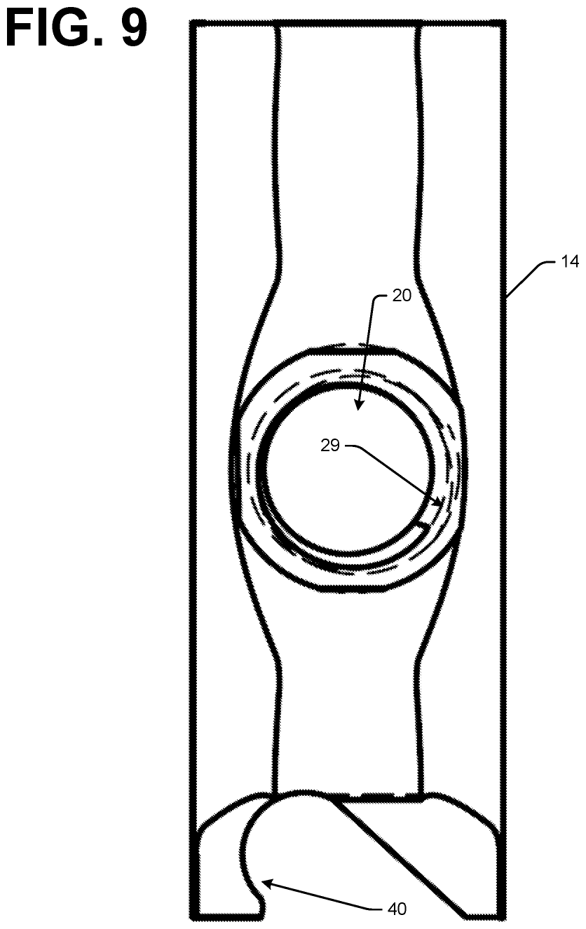

The internal threading can be seen on the keeper member 14 with reference to FIGS. 7-9. FIG. 6 is a transparent view showing internal aspects of a keeper member of the example portable door lock. FIG. 7 is a top view of the keeper member of the example portable door lock corresponding to FIG. 6. FIG. 8 is a side view of the keeper member of the example portable door lock corresponding to FIG. 6. FIG. 9 is another side view of the keeper member of the example portable door lock corresponding to FIG. 6. The keeper may have an internally threaded portion 28 in receiving opening 20. It is noted that the “ribs” may have a similar appearance to the internal threading 29 shown in the drawings, but would not need to be spirally connected for screwing on and off as would the threads 28. Therefore, ribs are not shown separately from the threads 28 in the drawings.

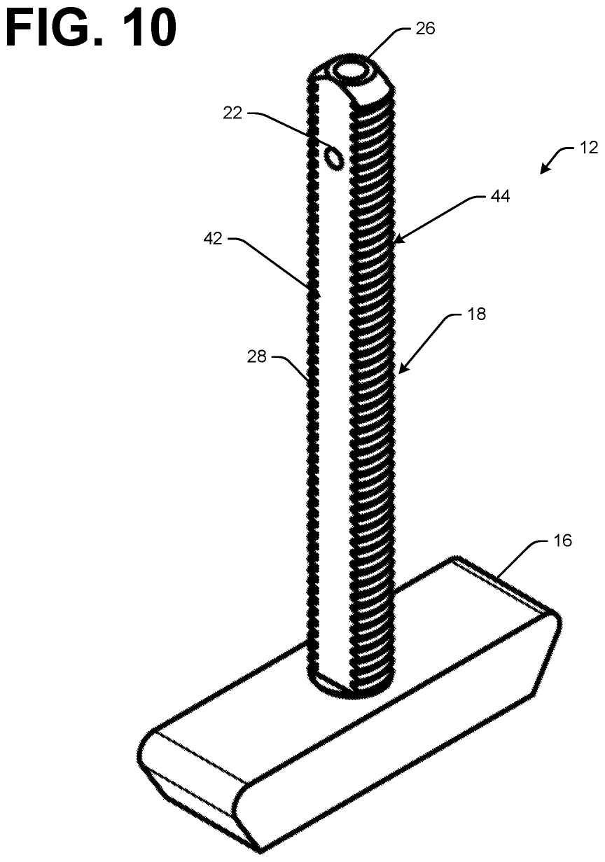

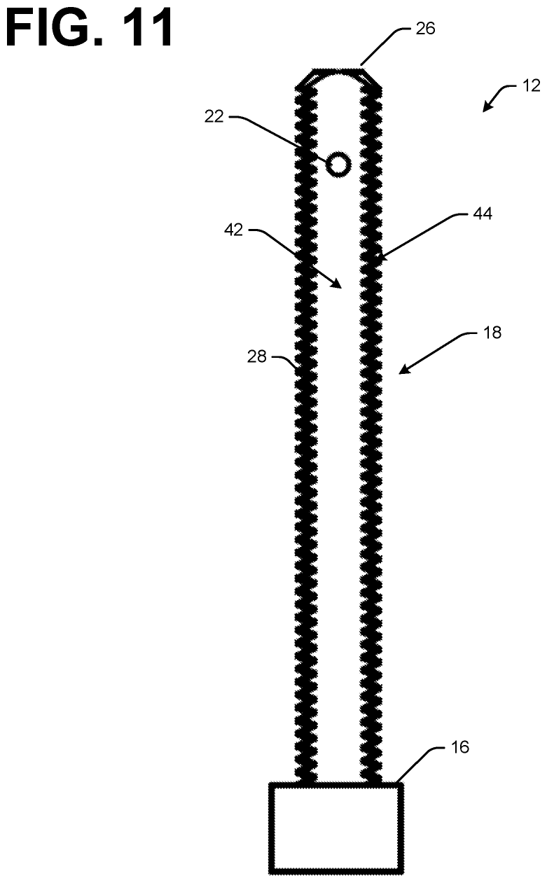

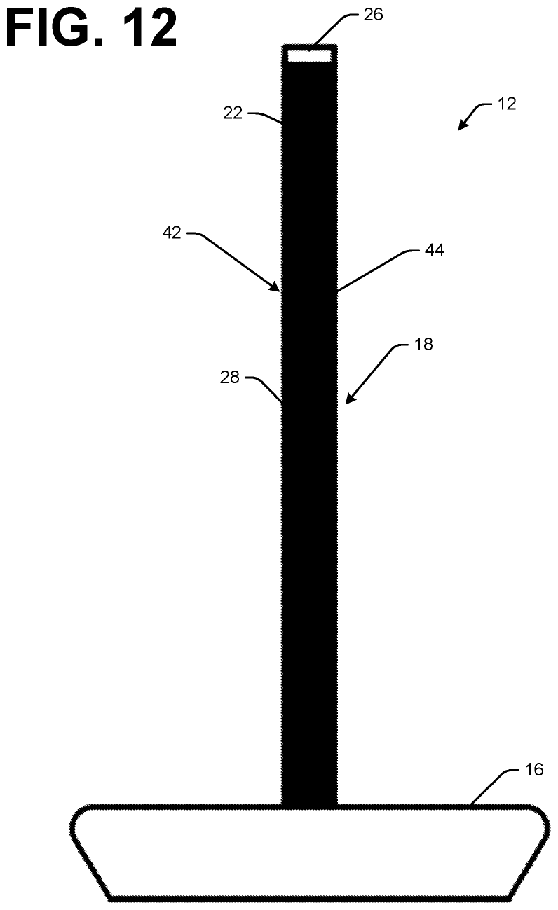

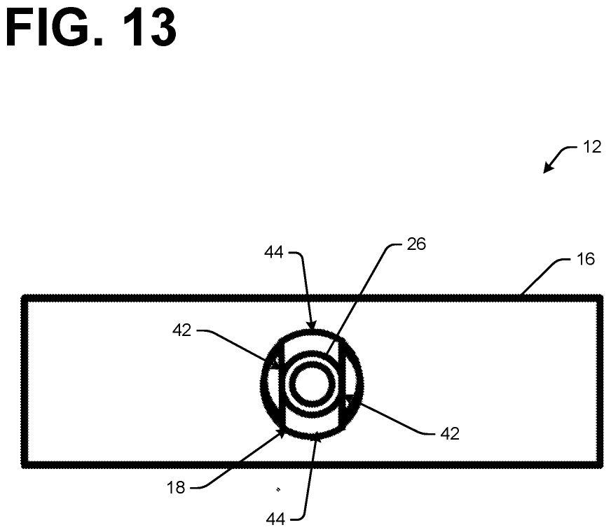

FIG. 10 is a perspective view of a latch member 12 of the example portable door lock 10. FIG. 11 is a side view of the latch member 12 of the example portable door lock 10 corresponding to FIG. 10. FIG. 12 is a top view of the latch member 12 of the example portable door lock 10 corresponding to FIG. 10. FIG. 13 is another side view of the latch member 12 of the example portable door lock 10 corresponding to FIG. 10.

The latch member 12 includes the cross member 16, and post 18 arranged substantially perpendicular to the cross member 16. The post 18 may have at least one flat side 42 and at least one ribbed side 44. In the drawings, the post 18 is shown having two flat sides corresponding to the sides that slide into the gap 6 when installed between a door 4 and a latch jamb 5. As already mentioned above, the flat side(s) reduce the width of the post 18 so that it more readily fits between relatively small gaps 6 as are typical on restroom doors. The post 18 is also shown having two ribbed or threaded sides so that the keeper member 14 can be engaged with the post 18 to secure the components together and thus “lock” the door 4.

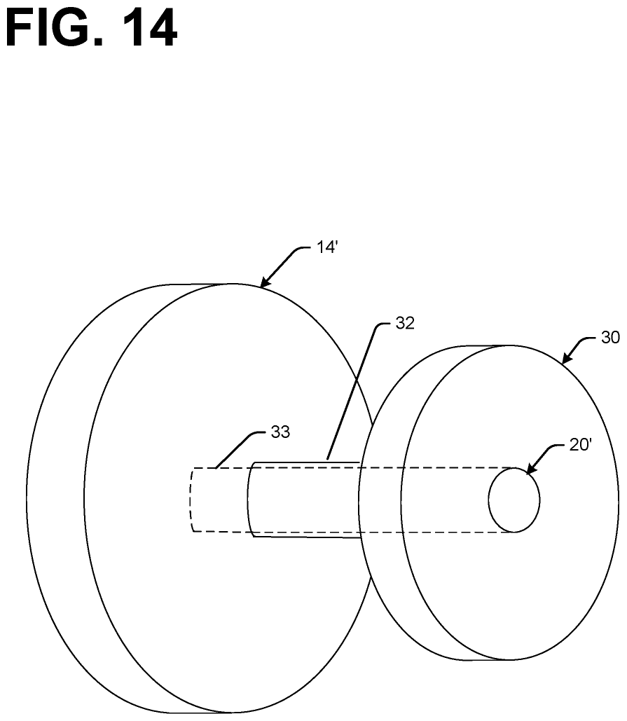

It is noted that the portable door lock 10 may be configured as a multifunctional tool, that is, providing other features in addition to the “locking” mechanism. By way of example, the portable door lock 10 may include a keyring 24 such as the keyring 24 on the post 18 shown in FIG. 4. In an example, the keeper member 14 may be configured with a bottle top opener 40. In another example, the keeper member 14 is configured as the multifunctional tool with a hanger for hanging apparel and bags. FIG. 14 is a perspective view of another example keeper member 14′ configured as a hanger 30. The hanger 30 is shown by way of illustration having the keeper member 14′ which serves as a base for contact with the door 4 and latch jamb 5, and a shaft 32 with interior chamber or pass-through 33 in connection with the opening 20′ (corresponding to opening 20 of keeper member 14 as shown in FIG. 1) for receiving the post therethrough (e.g., post 18 as shown in FIG. 1 or other suitable post). In this example, the hanger 30 has the shape of a knob, but any suitable shape and/or hook(s) may be provided.

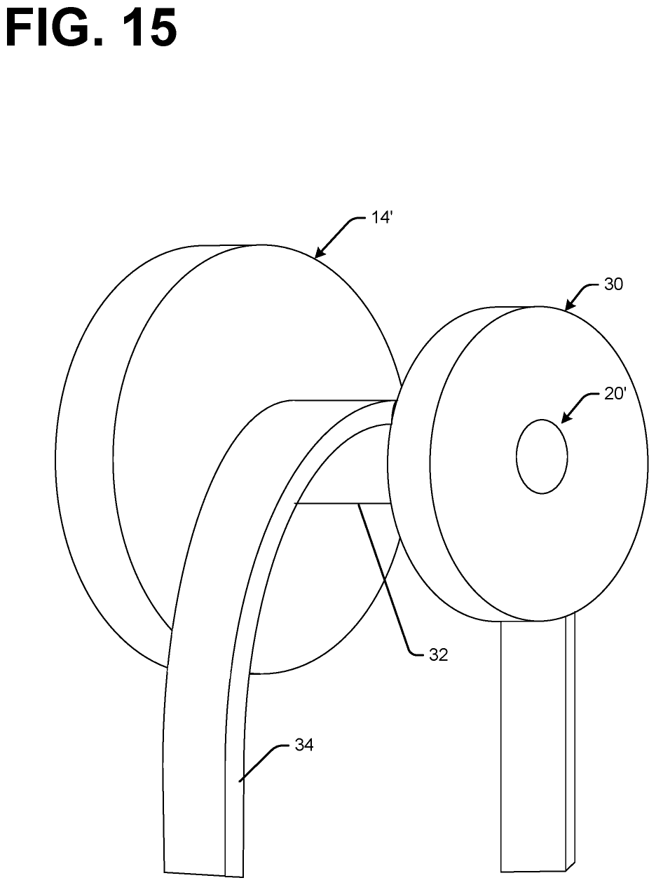

FIG. 15 is a perspective view of the example keeper member 14′ corresponding to FIG. 10 with a strap 34 shown hanging on the hanger 30 for purposes of illustration. Of course, anything that can hang on a hanger may be hung on the hanger 30 once the portable door lock 10 is secured in place, including but not limited to purses or other bags, backpacks, clothes hangers, jackets or other garments, etc. It will also be appreciated that the keeper member may be formed with or provided with a separate hook(s) instead of as the knob shown in FIGS. 14 and 15. These and other variations for providing additional features for the portable door lock 10 will be readily appreciated by those having ordinary skill in the art after becoming familiar with the teachings herein.

It is noted that the examples shown and described are provided for purposes of illustration and are not intended to be limiting. Still other examples are also contemplated.

1. A portable lock, comprising:
a latch member having a cross member connected with a post, the post arranged substantially perpendicular to the cross member; and
a keeper member having an opening formed therein to receive the post;
wherein the keeper member is positioned onto the post with the keeper member, the cross member, and the post together forming a latching assembly;
wherein the latching assembly is positioned with the post in a door jamb between a sidewall adjacent to a door and a side of the door, the cross member positioned against a first side of the door after the door is closed, and the keeper member positioned against a second side of the door after the door is closed, thereby securing the door in a closed configuration with the sidewall adjacent to the door.

2. The portable lock of claim 1, wherein the post has a length to accommodate different thickness doors.

3. The portable lock of claim 1, wherein the post is at least partially threaded, and the opening in the keeper member has a corresponding thread.

4. The portable lock of claim 3, wherein the keeper member is threaded onto the post to secure the door in the closed configuration, and the keeper member is unthreaded from the post to permit opening of the door.

5. The portable lock of claim 1, wherein the keeper member ratchets onto the post.

6. The portable lock of claim 1, wherein the keeper member is a multifunctional tool.

7. The portable lock of claim 6, wherein the keeper member is configured as the multifunctional tool with a bottle top opener.

8. The portable lock of claim 6, wherein the keeper member is configured as the multifunctional tool with a hanger for hanging apparel and bags.

9. The portable lock of claim 1, further comprising:
an opening formed through the post; and
a keyring connected through the opening formed through the post.

10. The portable lock of claim 1, further comprising a hardened tip for breaking glass.

11. A portable lock, comprising:
a cross brace;
a post arranged substantially perpendicular to the cross brace, the post having at least one flat side and at least one ribbed side; and
a keeper member having an opening formed therein to receive the post;
wherein the keeper member is positioned onto the post with the keeper member, the cross brace, and the post together forming a latching assembly;
wherein the post is slid between a sidewall adjacent to a door and a side of the door, after the door is closed, with the cross brace positioned against a first side of the door, and the keeper member positioned against a second side of the door, thereby securing the door closed.

12. The portable lock of claim 11, wherein the at least one flat side of the post configures the post to fit between the sidewall and the door when the door is closed.

13. The portable lock of claim 11, wherein the opening in the keeper member engages with the at least one ribbed side of the post.

14. The portable lock of claim 11, wherein the post is at least partially threaded, and the opening in the keeper member has a corresponding thread.

15. The portable lock of claim 14, wherein the keeper member is threaded onto the post to secure the door in the closed configuration, and the keeper member is unthreaded from the post to permit opening of the door.

16. The portable lock of claim 11, wherein the keeper member ratchets onto the post.

17. The portable lock of claim 11, wherein the keeper member has an integral bottle top opener.

18. The portable lock of claim 16, wherein the keeper member has a hanger portion.

19. The portable lock of claim 11, further comprising a hardened tip for breaking glass.

20. The portable lock of claim 11, further comprising:
an opening formed through the post; and
a keyring connected through the opening formed through the post.
